(19) United States
(12) Patent Application Publication
(10) Pub. No.: US 2013/0072312 A1
(43) Pub. Date: Mar. 21, 2013

(54) High Angle Plunge Joint

(71) Applicants: Hans Wormsbaecher, Lake Orion, MI (US); Steven C. Hahn, Shelby Township, MI (US)

(72) Inventors: Hans Wormsbaecher, Lake Orion, MI (US); Steven C. Hahn, Shelby Township, MI (US)

(21) Appl. No.: 13/234,769

(22) Filed: Sep. 16, 2011

(51) Int. Cl. F16D 3/34

(52) U.S. Cl. 464/145

(57) ABSTRACT

A high angle plunging constant velocity joint includes an outer race, an inner race, a plunging cage, a plurality of balls and a shaft. The outer race is defined by inner and outer surfaces, wherein the inner surface contains a plurality of double offset tracks. The inner race includes a plurality of corresponding double offset tracks disposed within a bore of the outer race. An outer surface of the inner race defines a first radius. The plunging cage is defined by an inner surface and an outer surface. The plunging cage is disposed between the inner race and outer race. The inner surface of the plunging cage is defined by a second radius that is less than the first radius. The plurality of balls are arranged within the cage and contact the double offset tracks of the inner and the outer race. The shaft is connected to the inner race.

### TECHNICAL FIELD

The disclosure generally relates to constant velocity joints and more particularly, to high angle, high-speed plunging constant velocity joints.

### BACKGROUND

Constant velocity joints (CV joints) are common components in all types of automotive vehicles. Constant velocity joints are typically used where transmission of constant velocity rotary motion is desired or required. In other words, constant velocity joints operate to transmit torque between two rotational members. The rotational members are typically interconnected by a cage or yoke that allow the rotational members to operate with their respective axes at a relative angle.

Common types of constant velocity joints include but are not limited to, plunging tripod, fixed tripod, plunging ball joint, and fixed ball joint. These joints can be used in a variety of different configurations including four wheel drive vehicles, all wheel drive vehicles, front wheel drive vehicles or rear wheel drive vehicles. Constant velocity joints are commonly classified by their operating characteristics. One important operating characteristic relates to the relative angular velocities of the two shafts connected thereby. In a constant velocity joint, the instantaneous angular velocities of the two shafts are always equal, regardless of the relative angular orientation between the two shafts. In a non-constant velocity joint the instantaneous angular velocities of the two shafts vary with the angular orientation (although the average angular velocities for a complete rotation are equal). Another important operating characteristic is the ability of the joint to allow relative axial movement between the two shafts. A fixed joint does not allow this relative movement, while a plunge joint does.

The plunging constant velocity joints allow axial movement during the operation of the constant velocity joint without the use of slip splines. However, plunging constant velocity joints sometimes initiate forces inherent of the particular constant velocity joint by function of design that result in vibration and noises through the driveline. The plunging types allow angular displacement along with the axial displacement along two axes thereof. In contrast, the fixed type constant velocity joints generally only allow angular displacement between two axes. The fixed constant velocity joints are better situated for higher operating angles than that of a plunging type constant velocity joint. All of these constant velocity joints are generally grease lubricated for life and sealed by a sealing boot when used on drive shafts. Thus, the constant velocity joints are sealed in order to retain grease inside the joint while keeping contaminates and foreign matter, such as dirt and water, out of the joint. The sealing protection of the constant velocity joint is necessary because contamination of the inner chamber causes internal damage and destruction of the joint which increases heat and wear on the boot, thus inevitably leading to premature boot and grease failures and hence failure of the overall joint. The problem of higher temperatures in high speed fixed constant velocity joint is greatly enhanced at the higher angles due to the rotational motion allowed by increased friction from the additional motion of plunging along the axis. Thus, the increased temperatures because of higher angles along with increased stresses on the boot because of higher angles may result in premature failures of the prior art constant velocity joints.

In a typical prior art constant velocity joint, a bulky and heavy outer race was used, having a spherical inner surface and a plurality of grooves on a surface therein. The joints also include an inner race, having a spherical outer surface with guide grooves formed therein. The prior art constant velocity joints used six torque transmitting balls, which are arranged between the guide grooves and the outer and inner race surfaces of the constant velocity joint by a cage retainer. The balls allow a predetermined displacement angle to occur through the joint thus, transmitting a constant velocity through the shafts of the automotive drive train system. The standard fixed high angle and high-speed constant velocity joints have no operational axial clearance between the inner race and the cage.

Therefore, there is a need in the art for a constant velocity joint that is capable of plunging during high angle and high-speed use while eliminating forces that result in vibration and noises through the driveline that are present in prior art plunging type constant velocity joints. There is also a need in the art for a plunging constant velocity joint that has a smaller package, increased efficiency and better thermal characteristics during high-speed, high angle operation.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise form and configurations shown in the drawings and disclosed in the following detailed description.

FIG. 1 shows a side view of an exemplary plunging constant velocity joint.

FIG. 2 shows a side view of a plunging constant velocity joint articulated to a predetermined angle.

FIG. 3 shows a top view of a grease cap.

FIG. 4 is a cross section taken along line 4-4 of the grease cap of FIG. 3.

FIG. 5 shows a top view of a boot cover.

FIG. 6 shows a cross section taken along line 6-6 of the boot cover of FIG. 5.

FIG. 7 shows a top view of an inner race.

FIG. 8 shows a cross section taken along line 8-8 of the inner race of FIG. 7.

FIG. 9 shows a cross section taken along line 9-9 of the inner race of FIG. 7.

FIG. 10 shows a cross section taken along line 10-10 of the inner race of FIG. 7.

FIG. 11 shows a partial cross section of a cage and ball as related to angles of track movement.

FIG. 12 shows a top view of an outer race.

FIG. 13 shows a side view of the outer race.

FIG. 14 shows a cross section taken along line 14-14 of the outer race of FIG. 12.

FIG. 15 shows a cross section taken along line 15-15 of the outer race of FIG. 12.

FIG. 16 shows a cross section taken along line 16-16 of the outer race of FIG. 12.

FIG. 17 shows a plan view of the inner race with a plurality of balls set therein.

FIG. 18 shows a close up of a ball track with a ball therein.

FIG. 19 shows a top view of the outer race with a plurality of balls therein.

FIG. 20 shows a plan view of a cage.

FIG. 21 shows a side view of the cage.

FIG. 22 shows a cross section of the cage taken along line 22-22 of FIG. 21.

FIG. 23 shows a portion of a cage in partial cross section according.

### DETAILED DESCRIPTION

Referring to the drawings, an exemplary arrangement of a plunging constant velocity joint 30 is shown. The plunging constant velocity joint 30 is generally configured as a high angle, high speed, ball type plunging constant velocity joint for use on propeller shafts, drive shafts or connected directly to a drive unit. The high angle can be defined as anything greater than or equal to nine degrees. These high angle joints tend to operate at high speeds and at higher temperatures than other joints.

A typical driveline for an all wheel drive vehicle includes a plurality of constant velocity joints with at least one being a plunging constant velocity joint 30. However, it should be noted that the constant velocity joint disclosed herein can also be used in rear wheel drive only vehicles, front wheel drive only vehicles, and four wheel drive vehicles. Generally, a driveline includes an engine that is connected to a transmission and a power take-off unit or transfer case. A front differential may have a right hand side shaft and a left hand side shaft each of which are connected to a wheel and deliver power to the wheels. On both ends of the right hand front side shaft and left hand front side shaft are constant velocity joints with at least one end being a plunging constant velocity joint. A propeller shaft connects the front differential and the rear differential to the transfer case or power take-off unit. The rear differential may include a right hand rear side shaft and a left hand rear side shaft each of which ends with a wheel on an end thereof. Generally, a constant velocity joint is located on both ends of the half shaft that connect to the wheel and the rear differential with at least one end being a plunging constant velocity joint 30. The propeller shaft generally may be a multi-piece propeller shaft that includes a plurality of carden joints and/or high speed plunging constant velocity joints 30. The plunging constant velocity joints 30 transmit power to the wheels through the drive shaft even if the wheels or the shaft have changing angles due to steering, raising or lowering of the suspension of the vehicle, etc. The plunging constant velocity joints 30 allow for transmission of constant velocities at a variety of angles which are found in everyday driving of automotive vehicles on both the half shafts and prop shafts of these vehicles. The plunging or axial movement feature enables the shaft to slide in or out creating a reduction in torque loads applied to the shaft or drive unit during various stop and go operations of the drive unit.

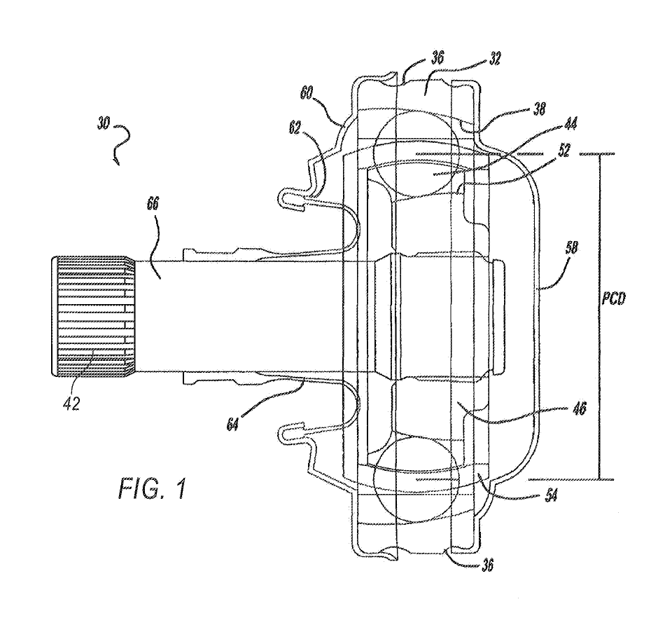

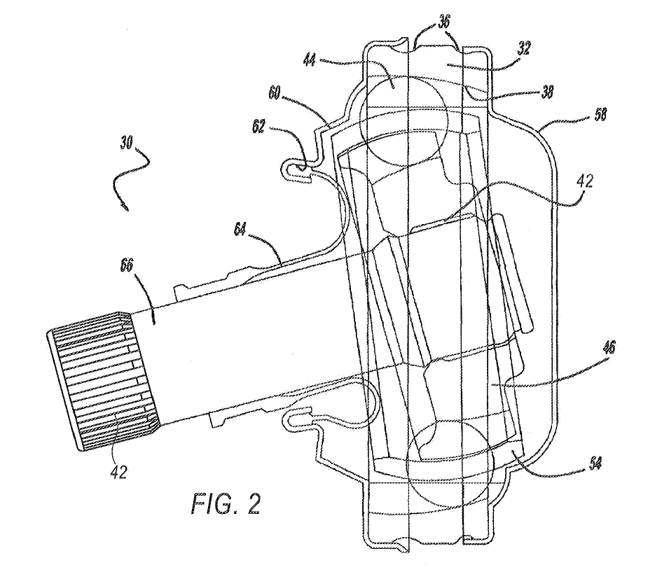

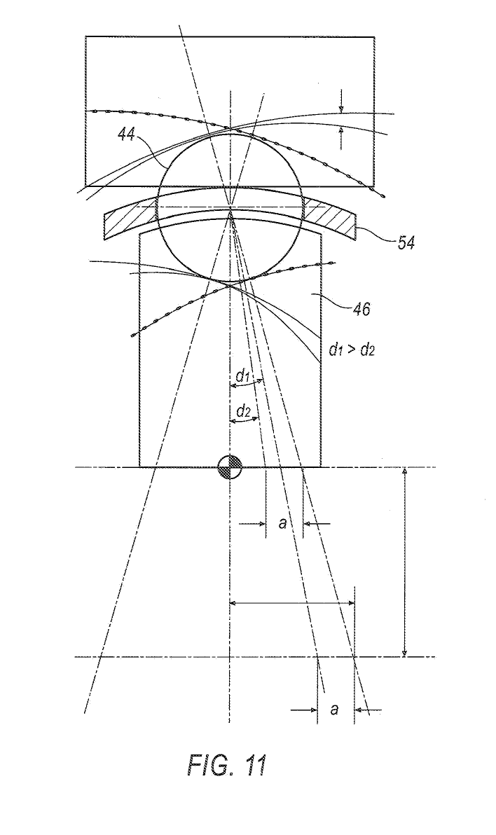

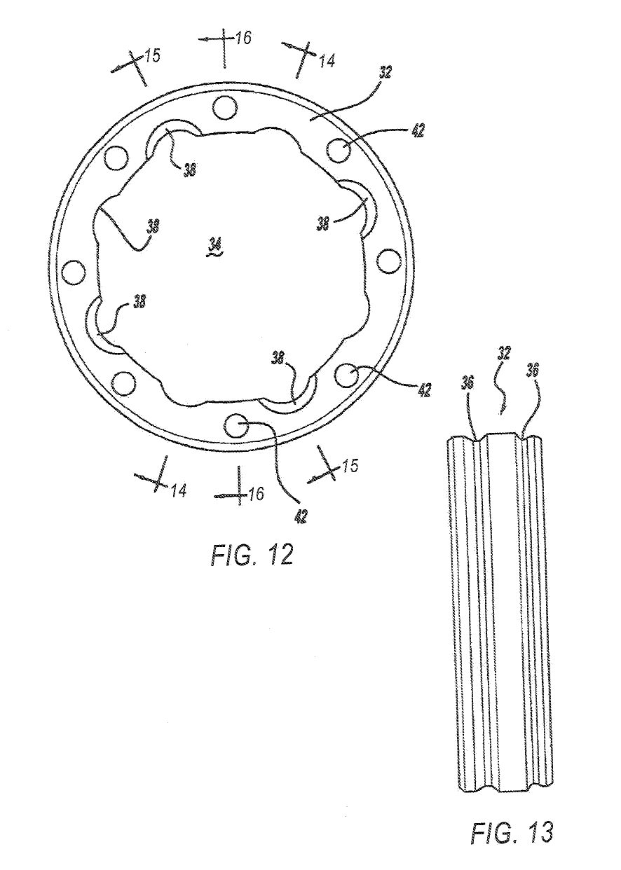

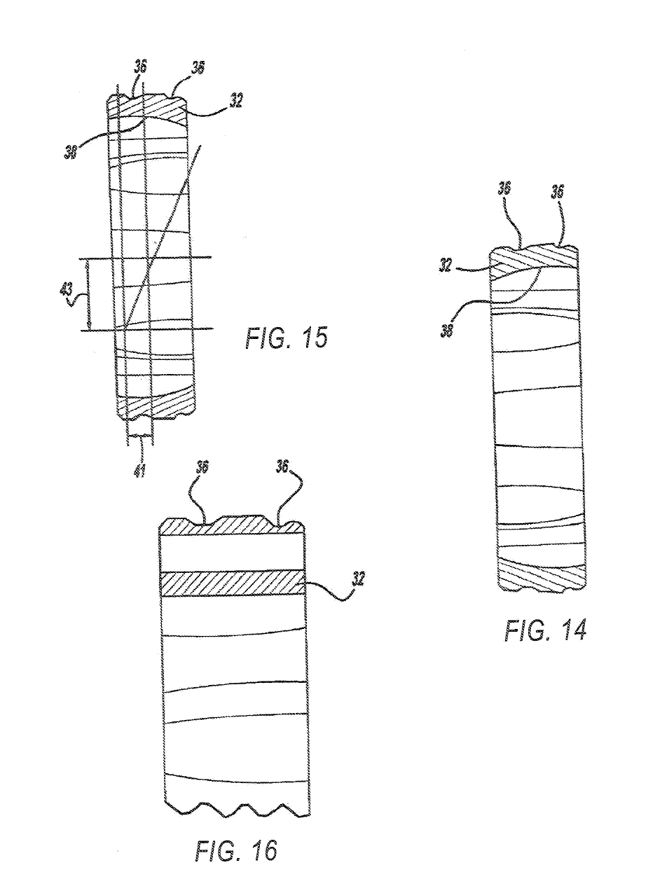

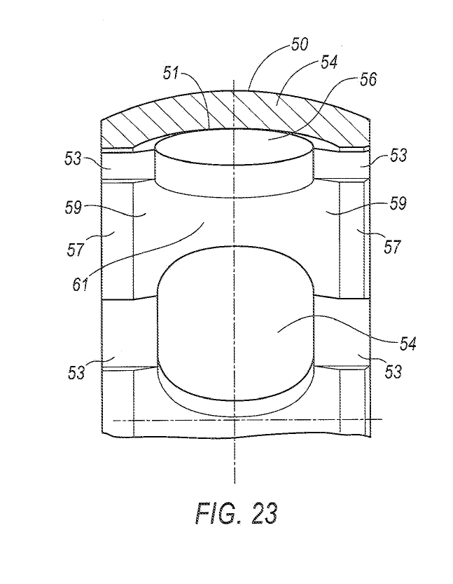

FIGS. 1 through 23 illustrate an exemplary arrangement of a plunging constant velocity joint 30. A high speed, high angle plunging constant velocity joint 30 is generally shown in FIGS. 1 and 2. The plunging constant velocity joint 30 includes an outer race 32 generally having a circumferential shaped bore 34 (see FIG. 12) therethrough. The outer race 32 generally has a ring like appearance. However, the outer race 32 may also be configured with a closed cupped shaped end (not shown) for direct attachment to a prop-shaft (not shown), thereby eliminating the need for a grease cap 58. On an outer surface of the plunging constant velocity joint outer race 32, at least one circumferential channel 36 is located. In one exemplary arrangement, channel 36 extends around the entire outer periphery of the outer race 32. Channel 36 allows for selective attachment of a grease cap 58 and a boot cover 60. The outer race 32 may also include a plurality of mounting orifices (not shown) located around an outer periphery thereof. In one exemplary arrangement, the mounting orifices are spaced equidistance from one another. The outer race 32 is generally made of a steel material, however it should be noted that any other type of metal material, hard ceramic, plastic, or composite material, etc. may also be used for the outer race 32. The material is required to be able to withstand the high speeds, temperatures and contact pressures of the plunging constant velocity joint 30.

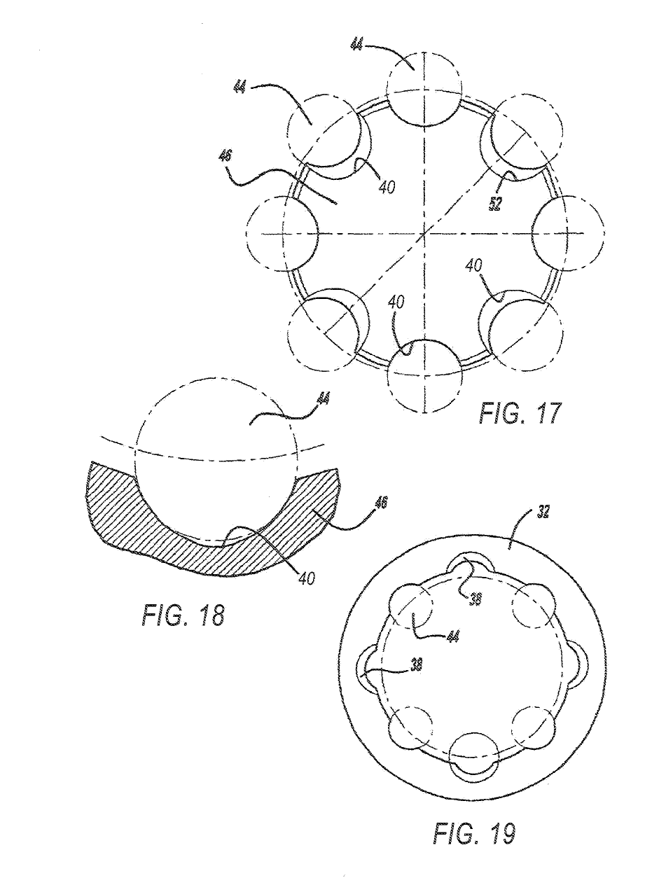

As seen in FIG. 12, for example, the outer race 32 also includes a plurality of axially opposed or double offset ball tracks 38 located on an inner surface thereof. The tracks 38 generally form a spherical shaped path within the inner surface of the outer race 32. The tracks 38 are axially opposed such that one half of the ball tracks 38 open to a side of the outer race 32 opposite to that of the other half of the ball tracks 38 in any number of patterns. In one embodiment, as shown in FIG. 17, every other track 38 opens towards one side of the outer race 32, while the alternating tracks 38 open towards the opposite side of the outer race 32. Therefore, the axial slope of the ball tracks 38 lay opposite to one another in the axial direction in an alternating pattern in this one embodiment. This ball track arrangement will ensure a decrease in the cage forces and will allow the elimination of at least one of the guidance spheres typically used in the prior art. This ball track arrangement will also improve the efficiency and thermal characteristics of the plunging constant velocity joint 30. The prior art had the ball tracks all opening or axially aligned on the same side of the outer race. Further, in one exemplary arrangement, the ball tracks 38 may also be of a gothic or elliptical shape, provided the pressure angle and conformity are maintained.

It should be noted that the plunging constant velocity joint 30 outer race 32 is thinner than the outer races of prior art plunging constant velocity joints. This will help reduce the weight of the outer race 32 while also reducing the package size of the plunging constant velocity joint 30. In one embodiment the outer race 32 is approximately 24 mm but may be any width less than 150 mm for a disc style joint. For a cupped or monoblock style joint, the outer race 32 may have a width greater than 150 mm, depending on the design requirements for the automotive vehicle. The use of the axially opposed tracks 38 allows a concavo-convex roller cage 54 to be centered between the outer race 32 and the inner race 46 while maintaining a predetermined distance from the edge surfaces of the outer race 32. This insures that the plunging constant velocity joint 30 is symmetrical in nature and the predetermined distance provides clearance allowing the concavo-convex roller cage 54 to move freely when the balls 44 roll within the constant velocity joint 30.

As discussed above, in the exemplary arrangement shown in the FIGS., the ball tracks 38 on the inner surface of the outer race 32 are double offset tracks. The double offset tracks 38 incorporate both a radial offset 43 in addition to an axial offset 41 (see, e.g., FIG. 15). This arrangement, will flatten the ball tracks 38 and promote rolling and therefore improve efficiency and durability of the plunging constant velocity joint 30. It should be noted that the double offset tracks 38 also result in better track edge support. This permits a higher pressure angle and a closer conformity of the ball 44 to the track 38. This arrangement will also allow the plunging constant velocity joint 30 to articulate to a higher angle than that of prior art joints while maintaining superior durability. Moreover, this will also allow the plunging constant velocity joint 30 to maintain engagement of the ball 44 and track 38 during three dimensional moving in the radial and axially plunging direction. The axial offset 41 and radial offset 43 have values that along with the pitch circle diameter (PCD), which is defined as the midpoint of a ball 44 on one side to the midpoint of a ball 44 on the other side through a center point of the plunging constant velocity joint 30, have predetermined ratios. The predetermined ratios of the axial offset 41, radial offset 43 and the pitch circle diameter (PCD) allow for better ball rolling and increased efficiency of the plunging constant velocity joint 30. It should be noted that in the embodiment shown in the drawings is a four plus four plunging constant velocity joint 30 which has a total of eight balls in the plunging constant velocity joint 30.

However, it should be noted that it is contemplated to make a joint with varying ball configurations while incorporating all of the features of the plunging constant velocity joint 30 disclosed herein. Additionally, the arrangement of the balls 44 within the concavo-convex roller cage 54 and contacting the double offset tracks 38 provides a low plunging force as the concavo-convex roller cage 54 may move half of the amount of travel, which allows the balls 44 to roll where previous designs resulted in the balls 44 potentially skidding in the tracks. Thus, the rolling action of the balls 44 may reduce friction, heat and vibration that may be inherent depending on the constant velocity joint.

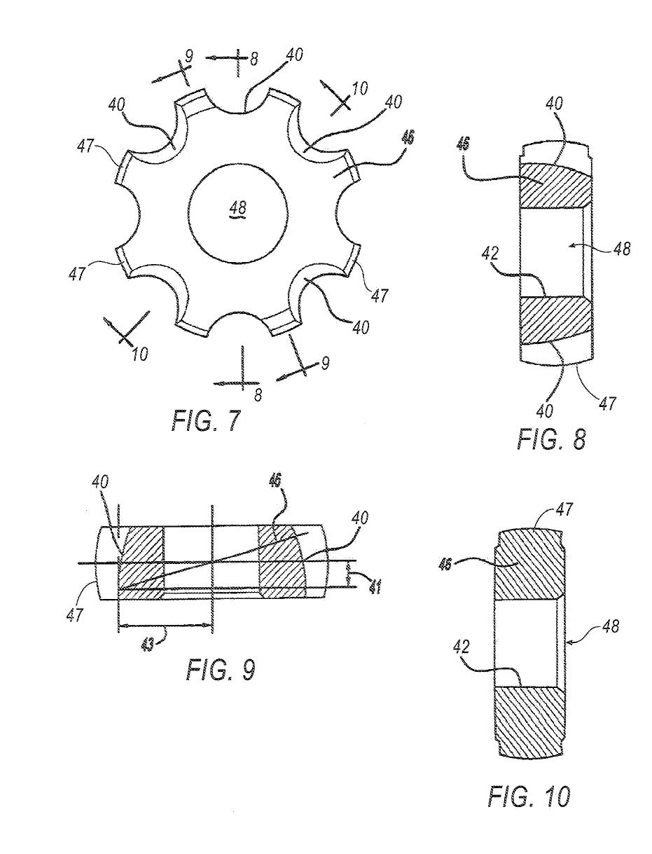

The plunging constant velocity joint 30 also includes an inner race 46 generally having a circumferential shape, best seen in FIGS. 7-10. The inner race 46 is arranged within the circumferential shaped bore 34 of the outer race 32. The inner race 46 may include an inner bore 48 that has a plurality of splines 42 on the inner surface thereof. The inner race 46 may also include an integrated shaft 66 extension having a plurality of splines 42 disposed at an end of the shaft 66, on either the shaft outer surface or the shaft inner surface thereof. The outer surface 47 of the inner race 46 is generally spheriodal in shape having a radius R1; a flat or land may be machined around the circumference of the outer surface 47 of the inner race 46. The inner race 46 outer surface 47 includes a plurality of ball tracks 40 that are axially opposed. It is noted that the inner race 46 outer surface 47 is not limited to the spherical shape and can be of any configuration that allows axial movement between the concavo-convex roller cage 54 and the inner race 46. The chosen shape must also be capable of receiving the ball tracks 40 while fitting within the concavo-convex roller cage 54 and the outer race 32. The ball tracks 40 generally have a spherical shape and are aligned with the ball tracks 38 on the outer race 32 such that the axial angle will open in a similar or the same direction as the ball track 38 directly aligned above it on the outer race 32. The ball tracks 40 on the outer spherical surface 47 of the inner race 46 have one half of the ball tracks 40 axially oriented in one way while the other half of the ball tracks 40 are axially oriented in the opposite direction. In the embodiment shown, the ball tracks 40 will open in an alternating pattern around the outer circumference of the inner race 46. The ball tracks 40 with the spherical or elliptical shape on the inner race 46 also include a double offset that includes both a radial offset (not shown) and an axial offset (not shown) to promote a flattening of the spherical tracks 40 thus leading to improve efficiency and durability of the plunging constant velocity joint 30 as discussed above for the outer race 32. It should be noted that in one embodiment the inner race 46 is made of steel, however any other, metal composite, hard plastic, ceramic, etc. may also be used.

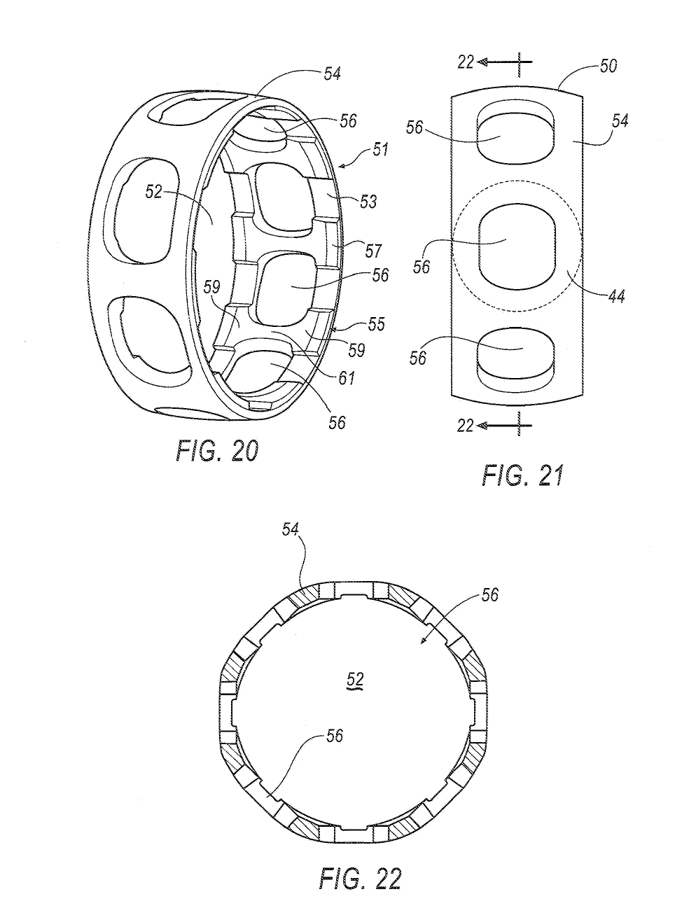

The plunging constant velocity joint 30 concavo-convex roller cage 54 (see FIGS. 20-23) may also have any shape that will allow axial movement between the inner race outer surface 47 and the concavo-convex roller cage 54. Specifically, the concavo-convex roller cage 54 may have generally flat internal and external surfaces or portions of the surface may be flat depending on the application. The axial movement between the inner race 47 and the concavo-convex roller cage 54 is a result of clearance between the inner race 47 and the concavo-convex roller cage 54, which provides rolling motion. Generally, this clearance allows for an approximate two to one axial motion ratio where the balls 44 having rolling motion in the axial direction. As illustrated, the concavo-convex roller cage 54 has a generally spherical ring-like outer periphery. The concavo-convex roller cage 54 includes an outer convex surface, 50 an inner concave surface 51 and a cage bore 52 therethrough. The outer convex surface 50 is substantially spherical while the inner concave surface 51 includes raised areas 55 having a radius R2 that corresponds to the R1 radius of the inner race outer surface 47. Where both R1 and R2 have the same center, R1 is greater than R2. The inner concave surface 51 includes a recessed area 53 having the same contour as the outer surface 50. The recessed area 53 provides clearance for the inner race 46 to slidingly engage the concavo-convex roller cage 54. The concave surface 51 raised area 55 further includes substantially flat outer interference ends 57, transition areas 59 and a travel area 61. The travel area 61 allows the inner race 46 to move in the axial direction, further providing at least two points of three dimensional plunging articulation of the plunging constant velocity joint 30. The concavo-convex roller cage 54 raised area 55 radius R2 provides both radial and axial clearance between the concavo-convex roller cage 54 and the inner race outer surface 47. This radial and axial clearance interaction between the concavo-convex roller cage 54 and the inner race outer surface 54 provides the plunge due to the clearance between the concavo-convex roller cage 54 and the inner race outer surface 47.

The plunging action is best defined by a series of ratios calculated to optimize plunge. Plunge is further defined by axial transmission of torque and can be achieved with the following ratios.

1. Plunge÷Inner race axial radius offset=6/3=2 (max);

2. Plunge÷Cage/Inner race axial clearance=6/3=2 (max);

3. Plunge÷steering angle=0.5÷1.3;

4. Plunge÷Δ PCD/Δ window=3.75÷15;

5. Plunge÷axial track offset=6/17=0.353;

6. Plunge÷radial track offset=6/7=0.857;

7. Plunge÷Cage Inner Radius−Outer Radius of inner race=6/1=6;

8. A PCD÷Δ window=0.4÷1.6.

It is noted that these ratios do not necessarily need to be present. However they are beneficial when optimizing the desired plunge in a plunging constant velocity joint 30.

The concavo-convex roller cage 54 is arranged within the circumferential shaped bore 34 of the outer race 32 such that it is not in contact with the inner surface of the outer race 32. The concavo-convex roller cage 54 has a plurality of oblong shaped orifices 56 through a surface thereof. The number of orifices 56 will match the number of ball tracks 38, 40 on the outer race 32 and inner race 46 of the plunging constant velocity joint 30. In one exemplary embodiment, such as that shown in the drawings, there will be eight orifices 56 therethrough. The concavo-convex roller cage 54 is centered and supported solely by the outer spherical surface of the inner race 46. This will allow for an efficiency improvement of the plunging constant velocity joint 30. With no contact between the outer race 32 inner surface and the outer surface of the concavo-convex roller cage 54, efficiency is improved, thereby reducing the likelihood of boot and grease thermal failures. The concavo-convex roller cage 54 is also designed such that it does not have typical cage grooves that would weaken the concavo-convex roller cage 54. This allows the inner race 46 to be assembled within the concavo-convex roller cage 54 without the use of the specialized cage grooves but through the use of recessed areas 53 as discussed above. The concavo-convex roller cage 54 along with the inner race 46 are preferably made of a steel material but any other hard metal material, plastic, composite or ceramic, etc. may also be used. The concavo-convex roller cage 54 in the present invention is nearly in equilibrium and therefore most of the contact loads cancel each other out. This will also help increase the efficiency of the plunging constant velocity joint 30. The plunging motion or axial movement allows the concavo-convex roller cage 54 to eliminate a greater amount of contact loads.

The plunging constant velocity joint 30 includes a plurality of balls 44. The balls 44 generally have a larger diameter, which is permitted since the assembly angle is smaller for the plunging constant velocity joint 30, than for most of the current art. The use of the larger diameter balls 44 also reduces the stress on the inner race 46. The larger diameter balls 44 are each arranged within one each of the orifices 56 of the concavo-con vex roller cage 54 and within a ball track 38, 40 of the outer race 32 and of the inner race 46. Therefore, the balls 44 will be capable of rolling in the axially opposed tracks 38, 40 aligned in the same direction. The use of the double offset means that the radial path of the balls travel is shallower thus allowing for a higher angle in a smaller, lighter plunging constant velocity joint 30.

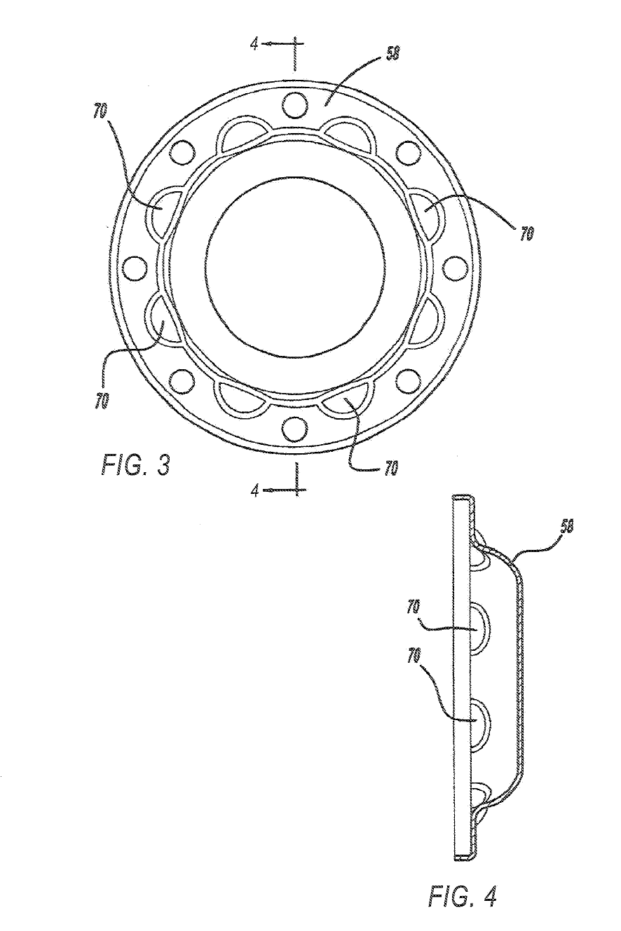

The plunging constant velocity joint 30 may use an integrated closed end (not shown) for direct attachment to a propshaft or drive unit. The plunging constant velocity joint 30 may also use a grease cap 58 on one end (shown in FIGS. 3-4). The grease cap 58 generally has a cup shaped appearance. The grease cap 58 is generally made of a metal material however any, plastic, rubber, ceramic or composite material may also be used. The cap 58 is press fit or connected to the outer surface of the outer race 32 via one of the circumferential channels 36 on the outer surface. However, any other securing method known may also be used such as fasteners, bonding, etc. The grease cap 58 will insure the grease, which is used as a lubricant, will remain within the plunging constant velocity joint 30. A vent may be placed through the cap 58 to relieve any internal pressure. As shown in FIGS. 3 and 4, the cap also includes a plurality of grooves 70 to allow for rotation of the balls 44 within the plunging constant velocity joint 30 at the high angles. The joint 30 is provided with minimal machine tolerance to allow for the introduction of the grease. Once the joint 30 is filled with grease, all inherent machine tolerances present in a typical joint will be removed thus eliminating axial and radial movement resulting from this tolerance.

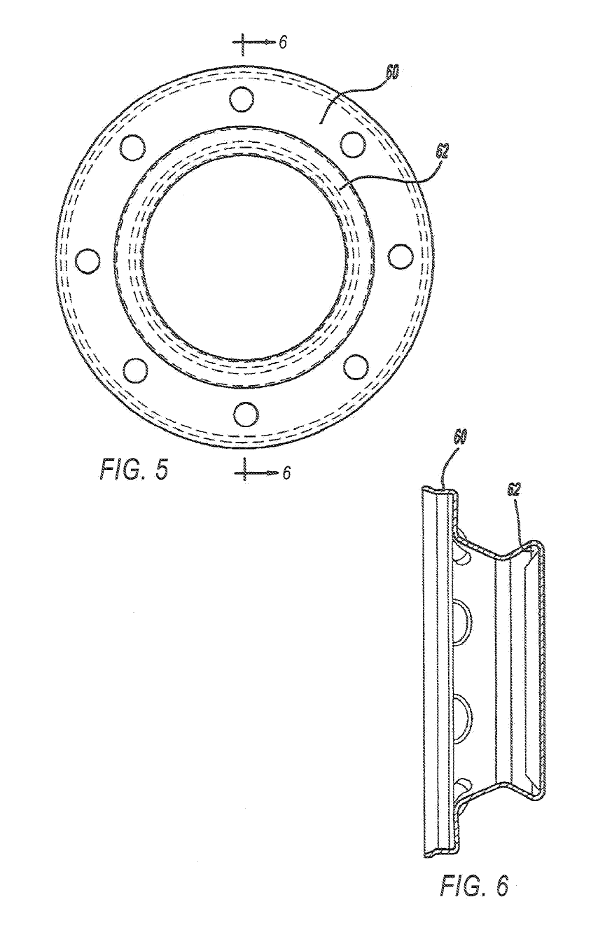

On an end opposite of the grease cap 58 of the outer race 32 is located a boot cover 60 (best seen in FIGS. 5-6), which generally has a circumferential shape. The boot cover 60 is connected to an outer surface of the outer race 32 either via a circumferential channel 36 on the outer surface thereof or by any other known securing means. The boot cover 60 includes a circumferential channel 62 at an end opposite of the end connected to the outer race 32 for securing a pliable boot 64 therein. The boot cover 60 is generally made of a metal material however any plastic, rubber, ceramic, composite, etc. may be used.

A pliable boot 64 is secured between the boot cover 60 and the shaft 66 of the plunging constant velocity joint 30. Any known securing method can be used to hold the boot 64 around the shaft 66 such as a boot clamp, fastener, etc. The pliable boot 64 is generally made of a urethane material but any other pliable material such as fabric, plastic, or rubber may also be used for the constant velocity joint boot 64 as long as it is capable of withstanding the high temperature and high rotational speeds of the plunging constant velocity joint 30. It should be noted that the boot 64 is arranged such that the boot 64 is set within the outer circumference of the concavo-convex roller cage 54. This will allow the boot 64 to move closer to the center line of the plunging constant velocity joint 30 thus decreasing the package size and reducing the stress on the boot 64 and hence reducing the likelihood of boot failure and constant velocity joint failure. FIG. 1 shows the plunging constant velocity joint 30 at an equilibrium position and shows the boot 64 within the outer diameter of the concavo-convex roller cage 54. FIG. 2 shows the boot 64 when the plunging constant velocity joint 30 is at a high angle, i.e., approximately 15 degrees. The boot 64 is still within the outer diameter of the concavo-convex roller cage 54 while also being closer to the center line of the joint 30, thus reducing any boot stress.

In one exemplary arrangement, the stub shaft 66 is a separate shaft, that is fixed, via the splines 42, to the inner race 46 of the plunging constant velocity joint 30. The stub shaft 66 generally is solid. The stub shaft 66 and propshaft tube will pass through the inner circumferential shaped bore 34 of the outer race 32 during the event of a collision, thus reducing the forces in the collision and absorbing energy as it collapses. It should be noted that the pitch circle diameter PCD and the size of the balls 44 are predetermined in such a way to allow a balance to occur such that the inner race 46 and balls 44 will be allowed to plunge from the outer race 32 during a crash incident, thus allowing the shaft and tube like members to collapse therein. The shaft 66 may also be an integrated hollow extension of the inner race 46 having internal splines 42 for receiving a shaft in a drive unit.

The axially opposed ball tracks 38 and 40 aligned on the outer race and inner race 46 in construction with the double offsets, the removal of the outer race spherical contact surfaces, and the judicious choice of the (PCD) and ball size permit a large improvement in efficiency while also improving durability. Predetermined ratios are contemplated with the plunging constant velocity joint 30 as described above. A ratio C1 which is the ball diameter divided by the pitch circle diameter should be greater than or equal to 0.217 but less than or equal to 0.275 in an eight ball unit as shown here. However, in a three or plus three joint, the C1 ratio could be greater than or equal to 0.217 and less than or equal to 0.318. It should be noted that if the C1 ratio is too large there will be a reduction in the concavo-convex roller cage 54 and inner race 46 strength as well as a loss of efficiency due to increased ball 44 sliding during the constant velocity joint 30 movement. However, if the ratio C1 is too small problems associated with assembling the inner race 46 into the concavo-convex roller cage 54 will occur. Furthermore, there will also be durability problems due to a lack of track edge support and reduced ball diameter. The lower ratio promotes ball rolling and thus increases efficiency of the plunging constant velocity joint 30.

A ratio X1 is defined as the axial offset divided by the pitch circle diameter and should be within the range of greater than or equal to 0.06753 while being less than or equal to 0.135. If the X1 ratio is too big the plunging constant velocity joint 30 will lose efficiency due to higher ball and cage forces. The larger variation of the ball path may also force an increase in the outside diameter of the outer race 32 to maintain adequate strength of the constant velocity joint 30. The larger ratio may also reduce track edge support at larger articulation angles as found in many current SUV vehicles. However, if the X1 ratio is too small there will be inadequate steering forces thus inhibiting the correct operation of the constant velocity joint 30. Additionally, a small X1 ratio tends to flatten the track and promotes better rolling behavior thus improving the efficiency of the plunging constant velocity joint 30.

Yet another ratio Y1 which is defined as the radial offset divided by the pitch circle diameter should be greater than or equal to 0.188. If this Y1 ratio is too small a larger variation of the ball path may force an increase in the outside diameter of the outer race 32 to maintain adequate strength of the plunging constant velocity joint 30. A small Y1 ratio may also reduce track edge support at larger articulation angles thus reducing the durability of the plunging constant velocity joint 30. A larger Y1 ratio flattens the track and improves efficiency by promoting better rolling behavior of the balls 44.

Therefore, the present disclosure of a high angle, high speed plunging constant velocity joint 30 uses a combination of innovations to create a smaller, more reliable and more efficient joint. The plunging constant velocity joint 30 has smaller part package given set capacity, while also reducing the weight of the plunging constant velocity joint 30. The plunging constant velocity joint 30 is designed to be at least twice as efficient as the standard high angle joint and will be more reliable thus increasing satisfaction of automotive manufacturers while reducing the number of joint failures and warranty issues thereafter. It should also be noted that various parameters such as the radial offset, the axial offset and the pit circle diameter may be adjusted to achieve specifically tuned objectives for the plunging constant velocity joint 30 such as but not limited to the amount of articulation angle needed or required for the constant velocity joint 30 in the drive train system. The use of the smaller diameter and reduced width outer race 32 will also reduce the cost and complexity of assembling the plunging constant velocity joint 30 for the automotive manufacturers thus reducing overall costs of the automotive vehicle. Hence, the high angle, i.e., greater than or equal to nine degree, high speed plunging constant velocity joint 30, has a better efficiency and more reliability than prior art high speed constant velocity joints that run at high temperatures thus causing premature boot and grease failures. The problem of the temperature based boot failures increases at the higher angles hence the current design limitations of the prior art constant velocity joint, need to be corrected to increase joint reliability and satisfaction. The higher temperatures and speed will produce higher stresses on the boot and contribute to many early failures of the plunging constant velocity joint. Therefore, the present disclosure of the high speed, high angle plunging constant velocity joint 30 overcomes known prior art problems by eliminating the spherical cage support surface on the outer race 32 in combination with a plurality of axially opposed tracks 38, 40, each of the tracks 38, 40 having a double offset therein. This will allow for high angles and while also promoting better efficiency and durability of the plunging constant velocity joint 30 via better ball rolling within the joint environment.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A high speed high angle plunging constant velocity joint comprising:
an outer race defined by inner and outer surfaces, wherein the inner surface contains a plurality of double offset tracks;
an inner race having a plurality of corresponding double offset tracks disposed within a bore of said outer race, wherein an outer surface of the inner race is defined by a first radius;
a plunging cage defined by an inner surface an outer surface, the plunging cage being disposed between the inner race and the outer race, wherein the inner surface of the plunging cage is defined by a second radius that is less than the first radius;
a plurality of balls arranged within the cage and contacting said double offset tracks of the inner and the outer race; and
a shaft connected to said inner race.

2. The plunging constant velocity joint of claim 1, wherein the cage is configured with clearance for three dimensional articulation in the axial and radial direction.

3. The plunging constant velocity joint of claim 1, wherein the cage includes at least one interference portion.

4. The plunging constant velocity joint of claim 1, wherein the cage includes a travel portion allowing axial movement of the shaft and inner race.

5. The plunging constant velocity joint of claim 4, wherein the axial movement is at least 2 mm.

6. The plunging constant velocity joint of claim 1, wherein the cage includes at least one transition portion.

7. The plunging constant velocity joint of claim 1, wherein the second radius of the plunging cage and the first radius of the inner race are defined by the same center.

8. The plunging constant velocity joint of claim 1, further comprising a predetermined clearance between the inner race and the cage providing rolling motion in an axial direction at a two to one axial motion ratio.

9. The plunging constant velocity joint of claim 1, further comprising a cap sealingly connected to an end of said outer race.

10. A high speed high angle plunging constant velocity joint comprising:
an outer race defined by inner and outer surfaces, wherein the inner surface contains a plurality of double offset tracks;
an inner race disposed within the bore of said outer race, wherein the inner race is defined by an outer surface, and wherein the outer surface further includes a plurality of double offset tracks corresponding to said outer race double offset tracks;
a cage configured with both axial and radial clearance disposed between the inner race and the outer race, wherein the axial and radial clearance provides three dimensional plunging articulation;
a plurality of balls arranged within the cage and contacting said double offset tracks of the inner and the outer race; and
a shaft connected to said inner race.

11. The plunging constant velocity joint of claim 10, wherein the cage includes at least one interference portion limiting the plunge, a transition portion, and at least one travel portion allowing axial movement of the shaft and inner race.

12. The plunging constant velocity joint of claim 10, further comprising a predetermined clearance between the inner race and the cage providing rolling motion in an axial direction at a two to one axial motion ratio.

13. The plunging constant velocity joint of claim 10, further comprising a pliable boot wherein said boot contains a lubricant.

14. The plunging constant velocity joint of claim 10, wherein the plunging articulation is at least 2 mm.

15. The plunging constant velocity joint of claim 10, further comprising at least three points of plunging articulation.

16. The plunging constant velocity joint of claim 10, wherein the cage is defined by an inner radius, R2 and the inner race outer surface is defined by an outer radius R1, wherein R1 is greater than R2, and wherein R1 and R2 have the same center.

17. A high speed high angle plunging constant velocity joint comprising:
an outer race having a bore therethrough, said bore is defined by an inner surface, wherein the inner surface contains a plurality of double offset tracks;
an inner race disposed within the bore of said outer race, wherein the inner race is defined by an outer surface having a plurality of double offset tracks corresponding to said outer race double offset tracks;
a cage having at least three points of three dimensional axial and radial articulation;
wherein said cage is disposed between the inner race and the outer race, wherein the cage contains an interference portion, a transition portion and a travel portion providing plunge;
a plurality of balls arranged within the cage and contacting said double offset tracks of the inner and the outer race; and
a shaft connected to said inner race.

18. The plunging constant velocity joint of claim 17, further comprising a predetermined clearance between the inner race and the cage providing rolling motion in an axial direction at a two to one axial motion ratio.

19. The plunging constant velocity joint of claim 17, wherein the plunging cage is defined by an inner radius. R2 and the inner race outer surface is defined by an outer radius R1, wherein R1 is greater than R2 and wherein R1 and R2 have the same center.

20. The plunging constant velocity joint of claim 17, wherein the cage is further comprises a plurality of oblong shaped orifices extending through the cage.
